(19) United States
(12) Patent Application Publication
(10) Pub. No.: US 2005/0233768 A1
(43) Pub. Date: Oct. 20, 2005

(54) Wireless transmitter and earphone based on 802.11a/b/g standard

(75) Inventors: Gun-Lin Guo, Tu-Cheng (TW); Shih-Heng Chen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/090,480

(22) Filed: Mar. 25, 2005

(30) Foreign Application Priority Data
Apr. 16, 2004 (TW) 93110629

(51) Int. Cl. H04M 1/00

(52) U.S. Cl. 455/557; 455/41.2

(57) ABSTRACT

A wireless transmitter (300) communicates with a wireless earphone (100) to obtain remote communications. The wireless earphone includes: a wireless network card (30′) complying with the 802.11a/b/g standard, for receiving data packets and unpacking them to release digital audio signals; a control processor (20′) connected with the wireless network card, for dealing with the digital audio signals; and a digital-to-analog converter (50) connected with the control processor, for converting the digital audio signals to analog audio signals. The wireless transmitter has a structure similar to that of the wireless earphone, except that the wireless transmitter has an analog-to-digital converter (10) instead of the digital-to-analog converter.

### BACKGROUND OF THE INVENTION

1. Field of the Invention

The present invention relates to wireless transmitters and earphones; and more particularly to a wireless transmitter that transmits audio signals complying with the 802.11a/b/g standard, and a wireless earphone that receives audio signals also complying with the 802.11a/b/g standard to attain remote communication.

2. Prior Art

Wireless earphones have been in general use for several years. Audio signals are transmitted and received over a high-frequency radio wavelength or an infrared wavelength. Generally, the high-frequency radio waves can be modulated by an analog modulation means and a digital modulation means.

The audio signals transmitted over the infrared wavelength have better timbre, but only when the transmitter (e.g.: a digital versatile disk (DVD) player, personal computer (PC)) and the receiver (e.g.: a wireless earphone) are aligned. Additionally, the audio signals that are transmitted by using the infrared wavelength are interrupted when physical impediments are located between the transmitter and the receiver.

Because noise signals may join the audio signals during the process of transmitting the audio signals by using the analog modulation means, it is difficult to filter out the noise signals from the audio signals. Furthermore, when the energy of the noise signals is large, the timbres of the audio signals can be very poor. The digital modulation means has a stronger noise insulating capability than that of the analog modulation means. Therefore, nowadays more and more wireless earphones transmit and receive the audio signals by using the digital modulation means.

Wireless digital transmission standards used in wireless earphones comprise user-defined wireless digital transmission standards, and universal wireless digital transmission standards such as the 802.11a, 802.11b and 802.11g standards. Several kinds of wireless earphones employing user-defined wireless digital transmission standards have been developed. For instance, Chinese Pat. Pub. No. 1419365A, published on May 21, 2003, discloses a teacher wireless earphone and a student wireless earphone in a wireless digital audio teaching system. The teacher wireless earphone and the student wireless earphone transmit and receive the audio signals by using the user-defined wireless digital transmission standard. Therefore the teacher wireless earphone and the student wireless earphone cannot match with multimedia devices (e.g., a DVD player, PC player). Similarly, U.S. Pat. No. 6,021,207, issued on Feb. 1, 2000, discloses a wireless open ear canal earpiece that can communicate with a remote device. The wireless open ear canal earpiece transmits and receives audio signals by using the user-defined wireless digital transmission standard. Therefore the wireless open ear canal earpiece cannot match with multimedia devices.

Wireless earphones using universal wireless digital transmission standards can solve above-described problem. There are a variety of universal wireless digital transmission standards, such as Bluetooth, HomeRF, 802.11a, 802.11b and 802.11g. Generally, the working range of the Bluetooth standard is about 10 meters, the operation frequency thereof is 2.45 GHz, and the transmission speed thereof is 10 Mbps. The HomeRF standard is developed by the HomeRF working group. The operation frequency of the HomeRF standard is the same as that of the Bluetooth standard. The working range of the HomeRF standard is about 100 meters. As universal wireless digital transmission standards in industry, the working ranges of the 802.11a, 802.11b and 802.11g standards are longer than those of the Bluetooth standard and the HomeRF standard. Generally, the working range of the 802.11b standard is about 100-300 meters, the operation frequency thereof is 2.4 GHz, and the transmission speed thereof is 11 Mbps. The 802.11g standard was developed based on the 802.11b standard. The operation frequency of the 802.11g standard is the same as that of the 802.11b standard. However, the working range of the 802.11g standard is shorter than that of the 802.11b standard. The transmission speed of the 802.11g standard is 54 Mbps. The working range of the 802.11a standard is the shorter than those of the 802.11b standard and the 802.11g standard. The operation frequency of the 802.11a standard is 5.8 GHz, and the transmission speed thereof is 54 Mbps. A notable advantage of the 802.11a standard is that its working frequency is 5.8 MHz, which can avoid frequency disturbances of 2.4 GHz.

In conclusion, wireless transmitters and wireless earphones complying with the 802.11a/b/g standard are able to match with multimedia devices (e.g., a DVD player, PC player). In addition, the wireless transmitters and the wireless earphone can transmit and receive audio signals over a large range. Furthermore, because the working bandwidth of the 802.11a/b/g standard is large, the audio signals need not be compressed and decompressed, which can ensure good timbre. Therefore, a wireless transmitter and a wireless earphone complying with the 802.11a/b/g standard are needed.

### SUMMARY OF THE INVENTION

Accordingly, an objective of the present invention is to provide a wireless transmitter for transmitting audio signals complying with the 802.11a/b/g standard, in order to realize transmission of audio signals over a large range.

Another objective of the present invention is to provide a wireless earphone for receiving audio signals complying with the 802.11a/b/g standard, in order to realize transmission of audio signals over a large range.

In order to accomplish the above-mentioned first objective, a wireless transmitter comprises: an analog-to-digital converter (ADC) for converting analog audio signals to digital audio signals; a control processor coupled to the ADC for dealing with the digital audio signals and providing destination address data of the digital audio signals; and a wireless network card coupled to the control processor for packing the digital audio signals and the destination address data; wherein the wireless network card complies with the 802.11a/b/g standard, and transmits the data packets comprising the digital audio signals and the destination address data.

In order to accomplish the above-mentioned second objective, a wireless earphone comprises: a wireless network card for receiving and unpacking data packets in order to release digital audio signals and address data, wherein the wireless network card complies with the 802.11a/b/g standard; a control processor coupled to the wireless network card for determine whether the data packets are transmitted from a transmitter based on the address data of the data packets, and dealing with the digital audio signals; and a digital-to-analog converter (DAC) connected to the control processor for converting the digital audio signals to analog audio signals.

Because the wireless transmitter and the wireless earphone comply with the 802.11a/b/g standard, the wireless transmitter and the wireless earphone can match with multimedia devices (e.g., a DVD player, PC player). In addition, the wireless transmitter and the wireless earphone can realize transmission and receipt of audio signals over a large range. Furthermore, the working bandwidth of the 802.11a/b/g standard is large, and the audio signals need not be compressed and decompressed, which can ensure good timbre.

Other objects, advantages and novel features of the present invention will be drawn from the following detailed description with reference to the attached drawings.

### BRIEF DESCRIPTION OF THE DRAWINGS

FIG. 1 is a block diagram of a wireless transmitter complying with the 802.11a/b/g standard in accordance with the preferred embodiment of the present invention.

FIG. 2 is a block diagram of a wireless earphone complying with the 802.11a/b/g standard in accordance with the preferred embodiment of the present invention.

FIG. 3 shows an application environment of the wireless transmitter of FIG. 1 and the wireless earphone of FIG. 2.

FIG. 4 shows another application environment of the wireless earphone of FIG. 2.

### DETAILED DESCRIPTION OF THE INVENTION

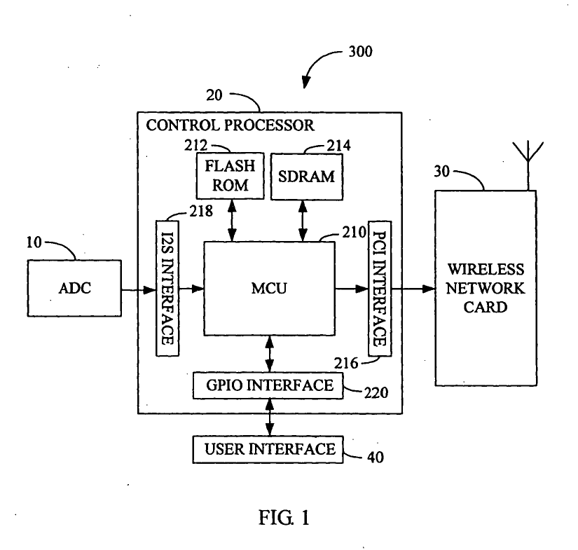

FIG. 1 shows a block diagram of a wireless transmitter 300. The wireless transmitter 300 comprises an analog-to-digital converter (ADC) 10, a control processor 20, a wireless network card 30, and a user interface 40. The wireless networks card 30 complies with the 802.11a/b/g standard. The control processor 20 comprises a microcontroller (microprogrammed control unit—MCU) 210, a flash read-only memory (flash ROM) 212, a synchronous dynamic random-access memory (SDRAM) 214, a peripheral component interconnect (PCI) interface 216, an Inter-IC sound (I2S) interface 218, and a general purpose input/output (GPIO) interface 220.

The ADC 10 is used for receiving analog audio signals and converting the analog audio signals to digital audio signals. The MCU 210 is coupled to the ADC 10 through the I2S interface 218. The I2S is an industry standard 3-wire interface (developed by Philips Corp.) for streaming the stereo audio signals between devices. A typical application of an I2S interface involves digital audio signals being transmitted between a CPU/DSP/MCU (central processing unit/digital signaling processor/microprogrammed control unit) and an ADC/DAC (analog-to-digital converter/digital-to-analog converter). The MCU 210 is used for dealing with the digital audio signals. The flash ROM 212 is coupled to the MCU 210 for storing software codes temporarily. The SDRAM 214 is coupled to the MCU 210 for providing a software operation platform. The MCU 210 is coupled to the wireless network card 30 through the PCI interface 216. The MCU 210 transmits the processed digital audio signals and corresponding destination address data to the wireless network card 30 by way of the PCI interface 216. The processed digital audio signals and corresponding destination address data as an identifier are packed and transmitted by the wireless network card 30 that complies with the 802.11a/b/g standard. In other embodiments, the wireless network card 30 can be coupled to the MCU 210 through other interfaces, such as a personal computer memory card international association (PCMCIA) interface, a universal serial bus (USB) interface, or a compact flash (CF) interface. The user interface 40 is coupled to the MCU 210 through the GPIO interface 220. The user interface 40 is used for adjusting volume and switching frequencies of transmission of the data packets comprising the digital audio signals and the destination address data, because the operation frequency of the wireless network card 30 may be 2.4 GHz or 5.8 GHz.

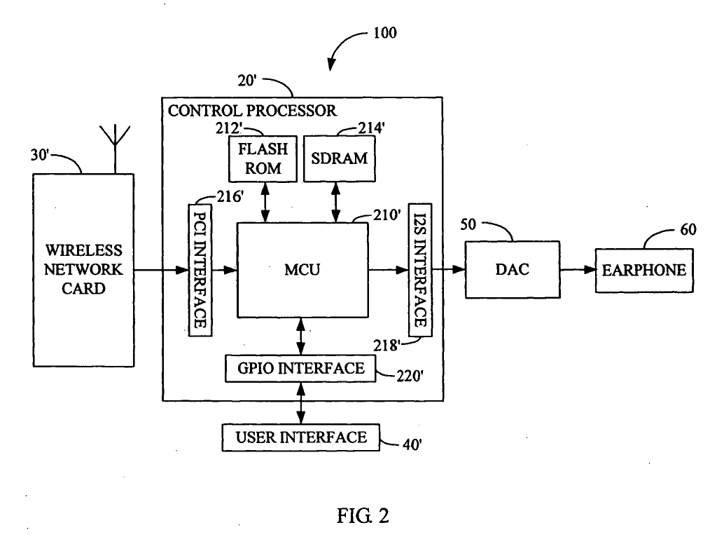

FIG. 2 shows a block diagram of the wireless earphone 100 complying with the 802.11a/b/g standard. The wireless earphone 100 comprises a control processor 20′, a wireless network card 30′, a user interface 40′, a DAC 50, and an earphone 60. The wireless network card 30′ complies with the 802.11a/b/g standard. The control processor 20′ comprises a microcontroller (microprogrammed control unit—MCU) 210′, a flash read-only memory (flash ROM) 212′, a synchronous dynamic random-access memory (SDRAM) 214′, a peripheral component interconnect (PCI) interface 216′, an Inter-IC sound (I2S) interface 218′, and a general purpose input/output (GPIO) interface 220′.

The controller processor 20′ and the user interface 40′ have the same theory and structure as the controller processor 20 and the user interface 40. The DAC 50 is used for converting the digital audio signals to the analog audio signals. In the present embodiment, the wireless network card 30′ is coupled to the MCU 210′ through the PCI interface 216′. In other embodiments, the wireless network card 30′ can be coupled to the MCU 210′ through other interfaces, such as a PCMCIA interface, a USB interface, or a CF interface. The DAC 50 is coupled to the MCU 210′ through the I2S interface 218′. The user interface 40′ is coupled to the MCU 210′ through the GPIO interface 220′.

In the wireless earphone 100, the wireless network card 30′ is used for receiving data packets transmitted from the wireless transmitter 300. Subsequently, the data packets are unpacked, and the address data and the digital audio signals of the data packets are released. The MCU 210′ determines whether the data packets are transmitted from the wireless transmitter 300 according to the address data. If so, the corresponding digital audio signals are dealt with and are sent to the DAC 50; otherwise, the data packets are discarded. The DAC 50 converts the digital audio signals to the analog audio signals, and then transmits the analog audio signals to the earphone 60.

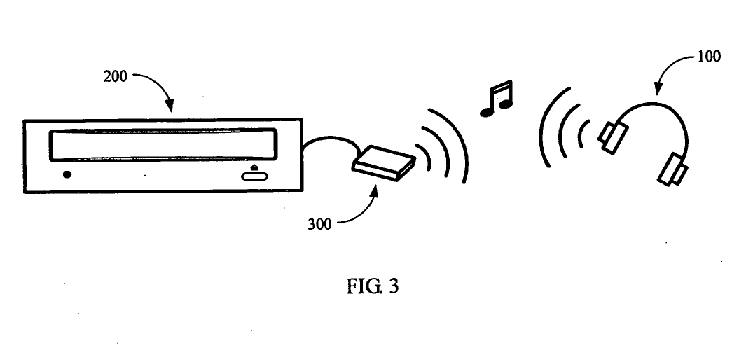

FIG. 3 schematically illustrates an application environment of the wireless transmitter 300 and the wireless earphone 100. When a multimedia device 200 is connected to the wireless transmitter 300, the multimedia device 200 can realize remote communication with the wireless earphone 100. Because the multimedia device 200 does not have a wireless transmission function, the multimedia device 200 must be connected to the wireless transmitter 300. The multimedia device 200 may for example be a DVD player or a CD player.

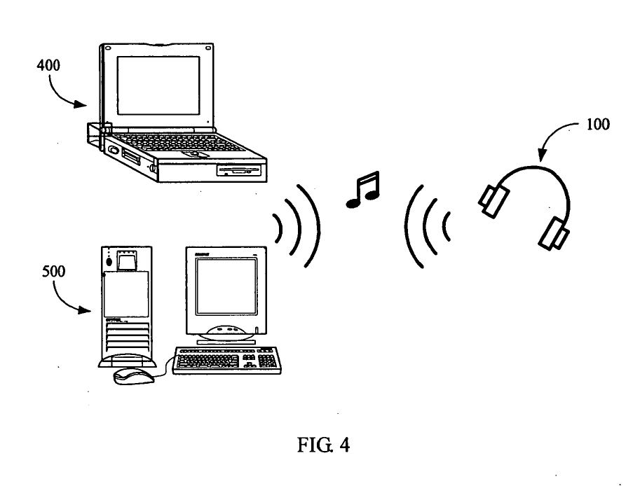

FIG. 4 schematically illustrates another application environment of the wireless earphone 100. A notebook computer 400 or a desktop computer 500 has a wireless network card complying with the 802.11a/b/g standard. Therefore the notebook computer 400 or the desktop computer 500 can remotely communicate with the earphone 100 without the wireless transmitter 300. The earphone 100 is able to communicate with any computer that has a wireless network card complying with the 802.11a/b/g standard.

Those skilled in the art will readily observe that numerous modifications and alterations of the described devices may be made while retaining the teachings of the invention. Accordingly, the above disclosure should be construed as merely being exemplary of the present invention as delineated by the appended claims and allowable equivalents thereof.

1. A wireless transmitter complying with the 802.11a/b/g standard, comprising:
an analog-to-digital converter (ADC) for converting analog audio signals to digital audio signals;
a control processor coupled to the ADC for dealing with the digital audio signals and providing destination address data of the digital audio signals; and
a wireless network card coupled to the control processor for packing the digital audio signals and the destination address data;
wherein the wireless network card complies with the 802.11a/b/g standard, and transmits the data packets comprising the digital audio signals and the destination address data.

2. The wireless transmitter in claim 1, wherein the control processor comprises a microcontroller (MCU) for dealing with the digital audio signals.

3. The wireless transmitter in claim 2, wherein the control processor further comprises a flash read-only memory (flash ROM) coupled to the MCU.

4. The wireless transmitter in claim 2, wherein the control processor further comprises a synchronous dynamic random-access memory (SDRAM) coupled to the MCU.

5. The wireless transmitter in claim 2, wherein the control processor further comprises an Inter-IC sound (I2S) interface for connecting the ADC and the MCU.

6. The wireless transmitter in claim 2, wherein the control processor further comprises an interface for connecting the wireless network card and the MCU.

7. The wireless transmitter in claim 6, wherein the interface is a peripheral component interconnect (PCI) interface, a personal computer memory card international association (PCMCIA) interface, a universal serial bus (USB) interface, or a compact flash (CF) interface.

8. The wireless transmitter in claim 2, further comprising a user interface for adjusting volume and switching frequencies of transmission of the data packets.

9. The wireless transmitter in claim 8, wherein the control processor further comprises a general purpose input/output (GPIO) interface for connecting the user interface and the MCU.

10. A wireless earphone complying with the 802.11a/b/g standard, comprising:
a wireless network card for receiving and unpacking data packets in order to release digital audio signals and address data, wherein the wireless network card complies with the 802.11a/b/g standard;
a control processor coupled to the wireless network card for determine whether the data packets are transmitted from a transmitter based on the address data of the data packets, and dealing with the digital audio signals; and
a digital-to-analog converter (DAC) connected to the control processor for converting the digital audio signals to analog audio signals.

11. The wireless earphone in claim 10, wherein the control processor comprises a microcontroller (MCU) for dealing with the digital audio signals.

12. The wireless earphone in claim 11, wherein the control processor further comprises a flash read-only memory (flash ROM) coupled to the MCU.

13. The wireless transmitter in claim 11, wherein the control processor further comprises a synchronous dynamic random-access memory (SDRAM) coupled to the MCU.

14. The wireless earphone in claim 11, wherein the control processor further comprises an interface for connecting the wireless network card and the MCU.

15. The wireless earphone in claim 14, wherein the interface is a peripheral component interconnect (PCI) interface, a personal computer memory card international association (PCMCIA) interface, a universal serial bus (USB) interface, or a compact flash (CF) interface.

16. The wireless earphone in claim 11, further comprising a user interface for adjusting volume and switching frequencies of receipt of the data packets.

17. The wireless earphone in claim 16, wherein the control processor further comprises a general purpose input/output (GPIO) interface for connecting the user interface and the MCU.

18. The wireless earphone in claim 11, wherein the control processor further comprises an Inter-IC sound (I2S) interface for connecting the DAC and the MCU.

19. A method to transmit digitized audio signals between a wireless earphone and a multimedia device, comprising:
retrieving analog audio signals from said multimedia device;
converting said analog audio signals into digital audio signals;
packing said digital audio signals with a predetermined identifier based on a universal wireless digital transmission standard;
transmitting said packed digital audio signals complying with said universal wireless digital transmission standard to said wireless earphone;
unpacking said packed digital audio signals;
verifying said identifier to identify said transmitted digital audio signals;
resuming said analog audio signals from said unpacked digital audio signals in case that said identifier is acceptable; and
playing said analog audio signals in said wireless earphone.

20. The method in claim 19, wherein said universal wireless digital transmission standard is one of standards of Bluetooth, HomeRF, 802.11a, 802.11b and 802.11g.
